(19) United States
(12) Patent Application Publication
(10) Pub. No.: US 2004/0251566 A1
(43) Pub. Date: Dec. 16, 2004

(54) Device and method for generating microbubbles in a liquid using hydrodynamic cavitation

(76) Inventor: Oleg V. Kozyuk, Westlake, OH (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 10/461,698

(22) Filed: Jun. 13, 2003

(51) Int. Cl. B01F 3/04

(52) U.S. Cl. 261/76; 261/DIG. 75

(57) ABSTRACT

A device and method of generating microbubbles in a liquid comprising feeding the liquid and a gas through a flow-through chamber at respective flow rates and passing the liquid and gas through at least two local constrictions of flow to create hydrodynamic cavitation fields downstream from each local constriction of flow to thereby generate microbubbles.

### BACKGROUND OF THE INVENTION

The present invention relates to a device and process for generating microbubbles in a liquid using hydrodynamic cavitation.

Because microbubbles have a greater surface area than larger bubbles, microbubbles can be used in a variety of applications. For example, microbubbles can be used in mineral recovery applications utilizing the floatation method where particles of minerals can be fixed to floating microbubbles to bring them to the surface. Other applications include u sing microbubbles as carriers of oxidizing agents to treat contaminated groundwater or using microbubbles in the treatment of waste water.

### BRIEF DESCRIPTION OF THE DRAWINGS

In the accompanying drawings which are incorporated in and constitute a part of the specification, embodiments of a device and method are illustrated which, together with the detailed description given below, serve to describe example embodiments of the device and method. It will be appreciated that the illustrated boundaries of elements (e.g., boxes or groups of boxes) in the figures represent one example of the boundaries. Also, it will be appreciated that one element may be designed as multiple elements or that multiple elements may be designed as one element. Furthermore, an element shown as an internal component of another element may be implemented as an external component and vice versa.

Like elements are indicated throughout the specification and drawings with the same reference numerals, respectively. Moreover, the drawings are not drawn to scale and the proportions of certain parts have been exaggerated for convenience of illustration.

FIG. 1 is a longitudinal cross-section of one embodiment of a hydrodynamic cavitation device 10 for generating microbubbles in a liquid;

FIG. 2 is a longitudinal cross-section of another embodiment of a hydrodynamic cavitation device 200 for generating microbubbles in a liquid;

FIG. 3 is a longitudinal cross-section of another embodiment of a hydrodynamic cavitation device 300 for generating microbubbles in a liquid;

FIG. 4 is a longitudinal cross-section of another embodiment of a hydrodynamic cavitation device 400 for generating microbubbles in a liquid; and

FIG. 5 is a longitudinal cross-section of another embodiment of a hydrodynamic cavitation device 500 for generating microbubbles in a liquid.

### DETAILED DESCRIPTION

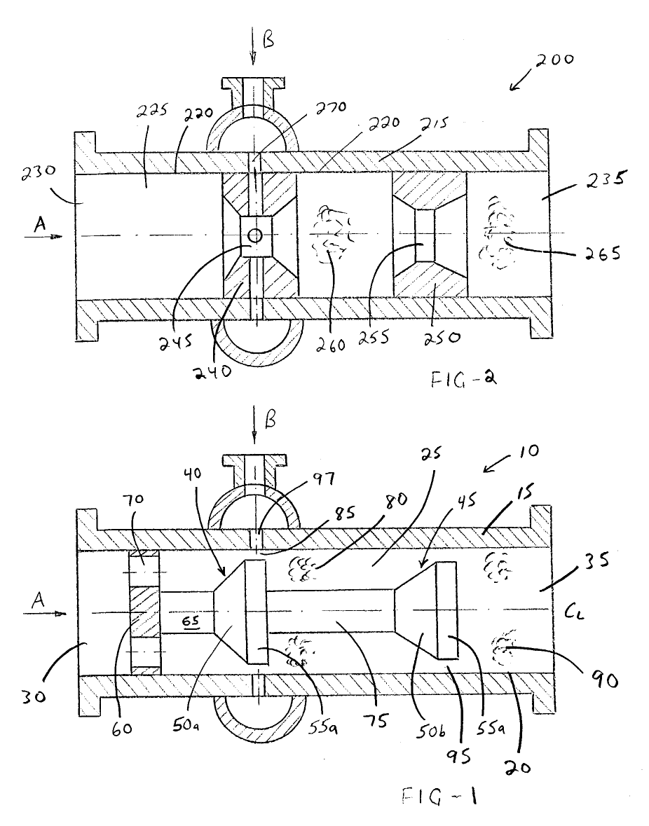

Illustrated in FIG. 1 is a longitudinal cross-section of one embodiment of a hydrodynamic cavitation device 10 for generating microbubbles in a liquid. The device 10 includes a wall 15 having an inner surface 20 that defines a flow-through channel or chamber 25 having a centerline CL. For example, the wall 15 can be a cylindrical wall that defines a flow-through channel having a circular cross-section. It will be appreciated that the cross-section of flow-through channel 25 may take the form of other geometric shapes such as square, rectangular, hexagonal, or any other complex shape. The flow-through channel 25 can further include an inlet 30 configured to introduce a liquid into the device 10 along a path represented by arrow A and an outlet 35 configured to exit the liquid from the device 10.

With further reference to FIG. 1, in one embodiment, the device 10 can further include multiple cavitation generators that generate a cavitation field downstream from each cavitation generator. For example, the device 10 can include two stages of hydrodynamic cavitation where a first cavitation generator can be a first baffle 40 and a second cavitation generator can be a second baffle 45. It will be appreciated that any number of stages of hydrodynamic cavitation can be provided within the flow-through channel 25. Furthermore, it will be appreciated that other types of cavitation generators may be used instead of baffles such as a Venturi tube, nozzle, orifice of any desired shape, or slot.

In one embodiment, the second baffle 45 is positioned within the flow-through channel downstream from the first baffle 40. For example, the first and second baffles 40, 45 can be positioned substantially along the centerline CL of the flow-through channel 25 such that the first baffle 40 is substantially coaxial with the second baffle 45.

To vary the degree and character of the cavitation fields generated downstream from the first and second baffles 40, 45, the first and second baffles 40, 45 can be embodied in a variety of different shapes and configurations. F or example, the first and second baffles 40, 45 can be conically shaped where the first and second baffles 40, 45 each include a conically-shaped surface 50a, 50b, respectively, that extends into a cylindrically-shaped surface 55a, 55b, respectively. The first and second baffles 40, 45 can be oriented such that the conically-shaped portions 50a, 50b, respectively, confront the fluid flow. It will be appreciated that the first and second baffles 40, 45 can be embodied in other shapes and configurations such as the ones disclosed in U.S. Pat. No. 5,969,207, issued on Oct. 19, 1999, which is hereby incorporated by reference in its entirety herein. Of course, it will be appreciated that the first baffle 40 can be embodied in one shape and configuration, while the second baffle 45 can be embodied in a different shape and configuration.

To retain the first baffle 40 within the flow-through channel 25, the first baffle 40 can be connected to a plate 60 via a shaft 65. It will be appreciated that the plate 60 can be embodied as a disk when the flow-through channel 25 has a circular cross-section, or the plate 60 can be embodied in a variety of shapes and configurations that can match the cross-section of the flow-through channel 25. The plate 60 can be mounted to the inside surface 20 of the wall 15 with screws or any other attachment means. The plate 60 can include a plurality of orifices 70 configured to permit liquid to pass therethrough. It will be appreciated that that a crosshead, post, propeller or any other fixture that produces a minor loss of liquid pressure can be used instead of the plate 60 having orifices 70. To retain the second baffle 45 within the flow-through channel 25, the second baffle 45 can be connected to the first baffle 40 via a stem or shaft 75 or any other attachment means.

In one embodiment, the first and second baffles 40, 45 can be configured to be removable and replaceable by baffles embodied in a variety of different shapes and configurations. It will be appreciated that the first and second baffles 40, 45 can be removably mounted to the stems 65, 75, respectively, in any acceptable fashion. For example, each baffle 40, 45 can threadly engage each stem 65, 75, respectively.

In one embodiment, the first baffle 40 can be configured to generate a first hydrodynamic cavitation field 80 downstream from the first baffle 40 via a first local constriction 85 of liquid flow. For example, the first local constriction 85 of liquid flow can be an area defined between the inner surface 20 of the wall 15 and the cylindrically-shaped surface 55a of the first baffle 40. Also, the second baffle 45 can be configured to generate a second hydrodynamic cavitation field 90 downstream from the second baffle 45 via a second local constriction 95 of liquid flow. For example, the second local constriction 95 can be an area defined between the inner surface 20 of the wall 15 and the cylindrically-shaped surface 55b of the second baffle 45. Thus, if the flow-through channel 25 has a circular cross-section, the first and second local constrictions 85, 95 of liquid flow can be characterized as first and second annular orifices, respectively. It will be appreciated that if the cross-section of the flow-through channel 25 is any geometric shape other than circular, then each local constriction of flow may not be annular in shape. Likewise, if a baffle is not circular in cross-section, then each corresponding local constriction of flow may not be annular in shape.

With further reference to FIG. 1, the flow-through channel 25 can further include a port 97 for introducing a gas into the flow-through channel 25 along a path represented by arrow B. For example, the gas can be air, oxygen, nitrogen, hydrogen, ozone, or steam. In one embodiment, the port 97 can be disposed in the wall 15 and positioned adjacent the first local constriction 85 of flow to permit the introduction of the gas into the liquid in the first local constriction 85 of flow. It will be appreciated that the port 97 can be disposed in the wall 15 anywhere along the axial length first local constriction 85 of flow. Furthermore, it will be appreciated that any number of ports can be provided in the wall 15 to introduce gas into the first local constriction 85 or the port 97 can be embodied as a slot to introduce gas into the first local constriction 85.

In operation of the device 10 illustrated in FIG. 1, the liquid enters the flow-through channel 25 via the inlet 30 and moves through the orifices 70 in the plate 60 along the fluid path A. The liquid can be fed through the flow-through channel 25 and maintained at any flow rate sufficient to generate a hydrodynamic cavitation field downstream from both the first and second baffles 40, 45. As the liquid moves through the flow-through channel 25, the gas is introduced into the first local constriction 85 via the port 97 thereby mixing the gas with the liquid as the liquid passes through the first local constriction 85. The gas can be introduced into the liquid in the first local constriction 85 and maintained at a flow rate different from the liquid flow rate. For example, a ratio between the gas flow rate and the liquid flow rate is about 0.1 or less. In other words, the ratio between the liquid flow rate and the gas flow rate can be at least about 10.

While passing through the first local constriction 85, the velocity of the liquid increases to a minimum velocity (i.e., velocity at which cavitation bubbles begin to appear) dictated by the physical properties of the liquid. The increased velocity of the liquid forms the first hydrodynamic cavitation field 80 downstream from the first baffle 40 thereby generating cavitation bubbles that grow when mixed with the gas. Upon reaching an elevated static pressure zone, the bubbles can be partially or completely squeezed thereby dissolving the gas into the liquid.

Once the gas microbubbles are generated after the first stage of hydrodynamic cavitation, the liquid and gas microbubbles continue to move towards the second baffle 45. While passing through the second local constriction 95, the velocity of the liquid increases to a minimum velocity (i.e., velocity at which cavitation bubbles begin to appear) dictated by the physical properties of the liquid. The increased velocity of the liquid forms the second hydrodynamic cavitation field 90 downstream from the second baffle 45 thereby generating cavitation bubbles. Upon reaching an elevated static pressure zone, a vacuum can be created in the second hydrodynamic cavitation field 90 to extract the dissolved gas from the liquid thereby generating microbubbles. The microbubbles can be smaller in size and more uniform than the microbubbles produced after the first stage of hydrodynamic cavitation. The liquid and microbubbles can then exit the flow-through channel 25 via the outlet 35.

Illustrated in FIG. 2 is a longitudinal cross-section of another embodiment of a hydrodynamic cavitation device 200 for generating microbubbles in a liquid. The device 200 includes a wall 215 having an inner surface 220 that defines a flow-through channel or chamber 225 having a centerline CL. For example, the wall 215 can be a cylindrical wall that defines a flow-through channel having a circular cross-section. It will be appreciated that the cross-section of flow-through channel 225 may take the form of other geometric shapes such as square, rectangular, hexagonal, or any other complex shape. The flow-through channel 225 can further include an inlet 230 configured to introduce a liquid into the device 200 along a path represented by arrow A and an outlet 235 configured to exit the liquid from the device 200.

With further reference to FIG. 2, in one embodiment, the device 200 can further include multiple cavitation generators that generate a cavitation field downstream from each cavitation generator. For example, the device 200 can include two stages of hydrodynamic cavitation where a first cavitation generator can be a first plate 240 having an orifice 245 disposed therein to produce a first local constriction of liquid flow and a second cavitation generator can be a second plate 250 having an orifice 255 disposed therein to produce a second local constriction of liquid flow. It will be appreciated that any number of stages of hydrodynamic cavitation can be provided within the flow-through channel 225. Furthermore, it will be appreciated that other types of cavitation generators may be used instead of plates having orifices disposed therein such as baffles.

Each plate 240, 250 can be mounted to the wall 215 with screws or any other attachment means to retain each plate 240, 250 in the flow-through channel 225. In another embodiment, the first and second plates 240, 250 can include multiple orifices disposed therein to produce multiple local constrictions of fluid flow. It will be appreciated that each plate can be embodied as a disk when the flow-through channel 225 has a circular cross-section, or each plate can be embodied in a variety of shapes and configurations that can match the cross-section of the flow-through channel 225.

In one embodiment, the second plate 250 is positioned within the flow-through channel downstream from the first plate 240. For example, the first and second plates 240, 250 can be positioned substantially along the centerline CL of the flow-through channel 225 such that the orifice 245 in the first plate 240 is substantially coaxial with the orifice in the second plate 250.

To vary the degree and character of the cavitation fields generated downstream from the first and second plates 240, 250, the orifices 245, 255 can be embodied in a variety of different shapes and configurations. The shape and configuration of each orifice 245, 255 can significantly affect the character of the cavitation flow and, correspondingly, the quality of crystallization. In one embodiment, the orifices 245, 255 can have a circular cross-section. It will be appreciated that each orifice 245, 255 can be configured in the shape of a Venturi tube, nozzle, orifice of any desired shape, or slot. Further, it will be appreciated that the orifices 245, 255 can be embodied in other shapes and configurations such as the ones disclosed in U.S. Pat. No. 5,969,207, which is hereby incorporated by reference in its entirety herein. Of course, it will be appreciated that the orifice 245 disposed in the first plate 240 can be embodied in one shape and configuration, while the orifice 255 disposed in the second plate 250 can be embodied in a different shape and configuration.

In one embodiment, the orifice 245 disposed in the first plate 240 can be configured to generate a first hydrodynamic cavitation field 260 downstream from the orifice 245. Likewise, the orifice 255 disposed in the second plate 250 can be configured to generate a second hydrodynamic cavitation field 265 downstream from the orifice 255.

With further reference to FIG. 2, the flow-through channel 225 can further include a port 270 for introducing a gas into the flow-through channel 225 along a path represented by arrow B. For example, the gas can be air, oxygen, nitrogen, hydrogen, ozone, or steam. In one embodiment, the port 270 can be disposed in the wall 215 and extended through the plate 240 to permit the introduction of the gas into the liquid in the first local constriction of flow. It will be appreciated that the port 270 can be disposed in the wall 215 anywhere along the axial length of the orifice 245 disposed in the first plate 240. Furthermore, it will be appreciated that any number of ports can be provided in the wall 215 to introduce gas into the orifice 245 disposed in the first plate 240 or the port 270 can be embodied as a slot to introduce gas into the orifice 245 disposed in the first plate 240.

In operation of the device 200 illustrated in FIG. 2, the liquid is fed into the flow-through channel 225 via the inlet 230 along the path A. The liquid can be fed through the flow-through channel 225 and maintained at any flow rate sufficient to generate a hydrodynamic cavitation field downstream from both the first and second plates 240, 250. As the liquid moves through the flow-through channel 225, the gas is introduced into the orifice 245 disposed in the first plate 240 via the port 270 thereby mixing the gas with the liquid as the liquid passes through the orifice 245 disposed in the first plate 240. The gas can be introduced into the liquid in the orifice 245 disposed in the first plate 240 and maintained at a flow rate different from the liquid flow rate. For example, a ratio between the gas flow rate and the liquid flow rate is about 0.1 or less. In other words, the ratio between the liquid flow rate and the gas flow rate can be at least about 10.

While passing through the orifice 245 disposed in the first plate 240, the velocity of the liquid increases to a minimum velocity (i.e., velocity at which cavitation bubbles begin to appear) dictated by the physical properties of the liquid. The increased velocity of the liquid forms the first hydrodynamic cavitation field 260 downstream from the first plate 240 thereby generating cavitation bubbles that grow when mixed with the gas. Upon reaching an elevated static pressure zone, the bubbles can be partially or completely squeezed thereby dissolving the gas into the liquid.

Once the gas microbubbles are generated after the first stage of hydrodynamic cavitation, the liquid and gas microbubbles continue to move towards the second plate 250. While passing through the orifice 255 disposed in the second plate 250, the velocity of the liquid increases to a minimum velocity (i.e., velocity at which cavitation bubbles begin to appear) dictated by the physical properties of the liquid. The increased velocity of the liquid forms the second hydrodynamic cavitation field 265 downstream from the second plate 250 thereby generating cavitation bubbles. Upon reaching an elevated static pressure zone, a vacuum can be created in the second hydrodynamic cavitation field 265 to extract the dissolved gas from the liquid thereby generating microbubbles. The microbubbles can be smaller in size and more uniform than the microbubbles produced after the first stage of hydrodynamic cavitation. The liquid and microbubbles can then exit the flow-through channel 225 via the outlet 235.

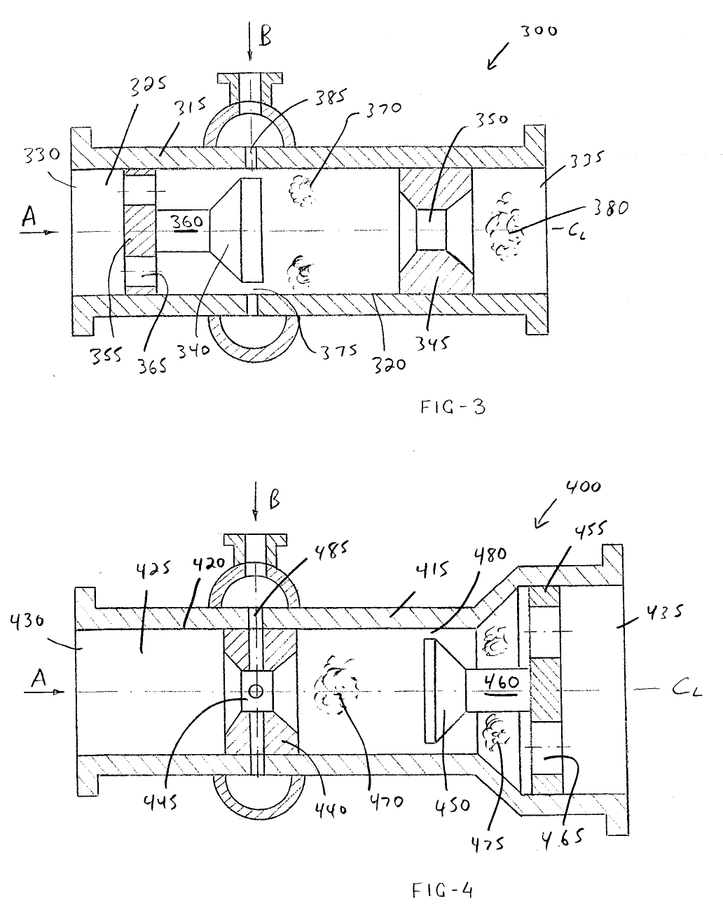

Illustrated in FIG. 3 is a longitudinal cross-section of another embodiment of a hydrodynamic cavitation device 300 for generating microbubbles in a liquid. The device 300 includes a wall 315 having an inner surface 320 that defines a flow-through channel or chamber 325 having a centerline C_{L}. The flow-through channel 325 can further include an inlet 330 configured to introduce a liquid into the device 300 along a path represented by arrow A and an outlet 335 configured to exit the liquid from the device 300.

With further reference to FIG. 3, in one embodiment, the device 300 can further include multiple cavitation generators that generate a cavitation field downstream from each cavitation generator. For example, the device 300 can include two stages of hydrodynamic cavitation where a first cavitation generator can be a baffle 340 and a second cavitation generator can be a plate 345 having an orifice 350 disposed therein to produce a local constriction of liquid flow. It will be appreciated that the plate 355 can be embodied as a disk when the flow-through channel 325 has a circular cross-section, or the plate 355 can be embodied in a variety of shapes and configurations that can match the cross-section of the flow-through channel 325. Further, it will be appreciated that any number of stages of hydrodynamic cavitation can be provided within the flow-through channel 325.

In one embodiment, the plate 345 is positioned within the flow-through channel downstream from the baffle 340. For example, the baffle 340 and the plate 345 can be positioned substantially along the centerline CL of the flow-through channel 325 such that the baffle 340 is substantially coaxial with the orifice 350 disposed in the plate 345.

To retain the baffle 340 within the flow-through channel 325, the baffle 340 can be connected to a plate 355 via a stem or shaft 360. It will be appreciated that the plate 355 can be embodied as a disk when the flow-through channel 325 has a circular cross-section, or the plate 355 can be embodied in a variety of shapes and configurations that can match the cross-section of the flow-through channel 325. The plate 355 can be mounted to the inside surface 320 of the wall 315 with screws or any other attachment means. The plate 355 can include a plurality of orifices 365 configured to permit liquid to pass therethrough. To retain the plate 345 within the flow-through channel 325, the plate 345 can be connected to the wall 315 with screws or any other attachment means.

In one embodiment, the baffle 340 can be configured to generate a first hydrodynamic cavitation field 370 downstream from the baffle 340 via a first local constriction 375 of liquid flow. For example, the first local constriction 375 of liquid flow can be an area defined between the inner surface 320 of the wall 315 and an outside surface of the baffle 340. Also, the orifice 350 disposed in the plate 345 can be configured to generate a second hydrodynamic cavitation field 380 downstream from the orifice 350.

With further reference to FIG. 3, the flow-through channel 325 can further include a port 385 for introducing a gas into the flow-through channel 325 along a path represented by arrow B. In one embodiment, the port 385 can be disposed in the wall 315 and positioned adjacent the first local constriction 375 of flow to permit the introduction of the gas into the liquid in the first local constriction 375 of flow. It will be appreciated that the port 385 can be disposed in the wall 315 anywhere along the axial length first local constriction 375 of flow. Furthermore, it will be appreciated that any number of ports can be provided in the wall 315 to introduce the gas into the first local constriction 375 or the port 385 can be embodied as a slot to introduce the gas into the first local constriction 375.

In operation of the device 300 illustrated in FIG. 3, the liquid enters the flow-through channel 325 via the inlet 330 and moves through the orifices 365 in the plate 360 along the path A. The liquid can be fed through the flow-through channel 325 and maintained at any flow rate sufficient to generate a hydrodynamic cavitation field downstream from both the first and second cavitation generators. As the liquid moves through the flow-through channel 325, the gas is introduced into the first local constriction 375 via the port 385 thereby mixing the gas with the liquid as the liquid passes through the first local constriction 375. The gas can be introduced into the liquid in the first local constriction 375 and maintained at a flow rate different from the liquid flow rate. For example, a ratio between the gas flow rate and the liquid flow rate is about 0.1 or less. In other words, the ratio between the liquid flow rate and the gas flow rate can be at least about 10.

While passing through the first local constriction 375, the velocity of the liquid increases to a minimum velocity (i.e., velocity at which cavitation bubbles begin to appear) dictated by the physical properties of the liquid. The increased velocity of the liquid forms the first hydrodynamic cavitation field 370 downstream from the baffle 340 thereby generating cavitation bubbles that grow when mixed with the gas. Upon reaching an elevated static pressure zone, the bubbles can be partially or completely squeezed thereby dissolving the gas into the liquid.

Once the gas microbubbles are generated after the first stage of hydrodynamic cavitation, the liquid and gas microbubbles continue to move towards the plate 350. While passing through the orifice 350 disposed in the plate 345, the velocity of the liquid increases to a minimum velocity (i.e., velocity at which cavitation bubbles begin to appear) dictated by the physical properties of the liquid. The increased velocity of the liquid forms the second hydrodynamic cavitation field 380 downstream from the plate 345 thereby generating cavitation bubbles. Upon reaching an elevated static pressure zone, a vacuum can be created in the second hydrodynamic cavitation field 380 to extract the dissolved gas from the liquid thereby generating microbubbles. The microbubbles can be smaller in size and more uniform than the microbubbles produced after the first stage of hydrodynamic cavitation. The liquid and microbubbles can then exit the flow-through channel 325 via the outlet 335.

Illustrated in FIG. 4 is a longitudinal cross-section of another embodiment of a hydrodynamic cavitation device 400 for generating microbubbles in a liquid. The device 400 includes a wall 415 having an inner surface 420 that defines a flow-through channel or chamber 425 having a centerline C_{L}. The flow-through channel 425 can further include an inlet 430 configured to introduce a liquid into the device 400 along a path represented by arrow A and an outlet 435 configured to exit the liquid from the device 400.

With further reference to FIG. 4, in one embodiment, the device 400 can further include multiple cavitation generators that generate a cavitation field downstream from each cavitation generator. For example, the device 400 can include two stages of hydrodynamic cavitation where a first cavitation generator can be a plate 440 having an orifice 445 disposed therein to produce a local constriction of liquid flow and a second cavitation generator can be a baffle 450. It will be appreciated that the plate 455 can be embodied as a disk when the flow-through channel 325 has a circular cross-section, or the plate 455 can be embodied in a variety of shapes and configurations that can match the cross-section of the flow-through channel 325. Further, it will be appreciated that any number of stages of hydrodynamic cavitation can be provided within the flow-through channel 425.

In one embodiment, the plate 440 is positioned within the flow-through channel upstream from the baffle 450. For example, the plate 440 and the baffle 450 can be positioned substantially along the centerline C_{L} of the flow-through channel 425 such that the baffle 450 is substantially coaxial with the orifice 445 disposed in the plate 440.

To retain the plate 440 within the flow-through channel 425, the plate 440 can be connected to the wall 415 with screws or any other attachment means. To retain the baffle 450 within the flow-through channel 425, the baffle 450 can be connected to a plate 455 via a stem or shaft 460. It will be appreciated that the plate 455 can be embodied as a disk when the flow-through channel 425 has a circular cross-section, or the plate 455 can be embodied in a variety of shapes and configurations that can match the cross-section of the flow-through channel 425. The plate 455 can be mounted to the inside surface 420 of the wall 415 with screws or any other attachment means. The plate 455 can include a plurality of orifices 465 configured to permit liquid to pass therethrough.

In one embodiment, the orifice 445 disposed in the plate 450 can be configured to generate a first hydrodynamic cavitation field 470 downstream from the orifice 245. Also, the baffle 450 can be configured to generate a second hydrodynamic cavitation field 475 downstream from the baffle 450 via a local constriction 480 of liquid flow. For example, the local constriction 475 of liquid flow can be an area defined between the inner surface 420 of the wall 415 and an outside surface of the baffle 450.

With further reference to FIG. 4, the flow-through channel 425 can further include a port 485 for introducing a gas into the flow-through channel 425 along a path represented by arrow B. In one embodiment, the port 485 can be disposed in the wall 415 and extended through the plate 440 to permit the introduction of the gas into the liquid in the local constriction 480 of flow. It will be appreciated that the port 485 can be disposed in the wall 415 anywhere along the axial length of the orifice 445 disposed in the plate 440. Furthermore, it will be appreciated that any number of ports can be provided in the wall 415 to introduce gas into the orifice 445 disposed in the plate 440 or the port 485 can be embodied as a slot to introduce gas into the orifice 445 disposed in the plate 440.

In operation of the device 400 illustrated in FIG. 4, the liquid is fed into t he flow-through channel 425 via the inlet 430 along the path A. The liquid can be fed through the flow-through channel 425 and maintained at any flow rate sufficient to generate a hydrodynamic cavitation field downstream from both the first and second cavitation generators. As the liquid moves through the flow-through channel 425, the gas is introduced into the orifice 445 disposed in the plate 440 via the port 485 thereby mixing the gas with the liquid as the liquid passes through the orifice 445. The gas can be introduced into the liquid in the orifice 445 disposed in the plate 440 and maintained at a flow rate different from the liquid flow rate. For example, a ratio between the gas flow rate and the liquid flow rate is about 0.1 or less. In other words, the ratio between the liquid flow rate and the gas flow rate can be at least about 10.

While passing through the orifice 445 disposed in the plate 440, the velocity of the liquid increases to a minimum velocity (i.e., velocity at which cavitation bubbles begin to appear) dictated by the physical properties of the liquid. The increased velocity of the liquid forms the first hydrodynamic cavitation field 470 downstream from the plate 440 thereby generating cavitation bubbles that grow when mixed with the gas. Upon reaching an elevated static pressure zone, the bubbles can be partially or completely squeezed thereby dissolving the g as into the liquid.

Once the gas microbubbles are generated after the first stage of hydrodynamic cavitation, the liquid and gas microbubbles continue to move towards the baffle 450. While passing through the local constriction 480 of flow, the velocity of the liquid increases to a minimum velocity (i.e., velocity at which cavitation bubbles begin to appear) dictated by the physical properties of the liquid. The increased velocity of the liquid forms the second hydrodynamic cavitation field 475 downstream from the baffle 450 thereby generating cavitation bubbles. Upon reaching an elevated static pressure zone, a vacuum can be created in the second hydrodynamic cavitation field 475 to extract the dissolved gas from the liquid thereby generating microbubbles. The microbubbles can be smaller in size and more uniform than the microbubbles produced after the first stage of hydrodynamic cavitation. The liquid and microbubbles can then exit the flow-through channel 425 via the outlet 435.

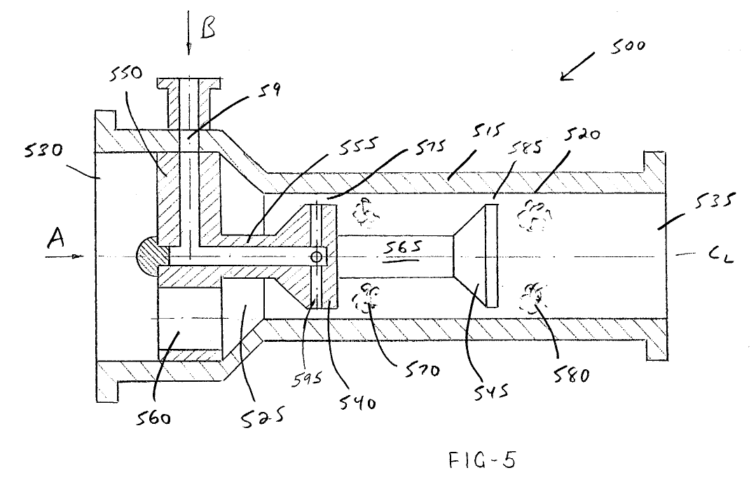

Illustrated in FIG. 5 is a longitudinal cross-section of another embodiment of a hydrodynamic cavitation device 500 for generating microbubbles in a liquid. The device 500 includes a wall 515 having an inner surface 520 that defines a flow-through channel or chamber 525 having a centerline C_{L}. The flow-through channel 525 can further include an inlet 530 configured to introduce a liquid into the device 500 along a path represented by arrow A and an outlet 535 configured to exit the liquid from the device 500.

With further reference to FIG. 5, in one embodiment, the device 500 can further include multiple cavitation generators that generate a cavitation field downstream from each cavitation generator. For example, the device 500 can include two stages of hydrodynamic cavitation where a first cavitation generator can be a first baffle 540 and a second cavitation generator can be a second baffle 345. It will be appreciated that any number of stages of hydrodynamic cavitation can be provided within the flow-through channel 525.

In one embodiment, the first baffle 545 is positioned within the flow-through channel 525 downstream from the first baffle 540. For example, the first and second baffles 540, 545 can be positioned substantially along the centerline CL of the flow-through channel 525 such that the first baffle 540 is substantially coaxial with the second baffle 545.

To vary the degree and character of the cavitation fields generated downstream from the first and second baffles 540, 545, the first and second baffles 540, 545 can be embodied in a variety of different shapes and configurations. It will be appreciated that the first and second baffles 540, 545 can be embodied in other shapes and configurations such as the ones disclosed in U.S. Pat. No. 5,969,207, issued on Oct. 19, 1999, which is hereby incorporated by reference in its entirety herein. Of course, it will be appreciated that the first baffle 540 can be embodied in one shape and configuration, while the second baffle 545 can be embodied in a different shape and configuration.

To retain the first baffle 540 within the flow-through channel 525, the first baffle 540 can be connected to a plate 550 via a stem or shaft 555. The plate 550 can be mounted to the inside surface 520 of the wall 515 with screws or any other attachment means. The plate 550 can include at least one orifice 560 configured to permit liquid to pass therethrough. To retain the second baffle 545 within the flow-through channel 525, the second baffle 545 can be connected to the first baffle 540 via a stem or shaft 565 or any other attachment means.

In one embodiment, the first baffle 540 can be configured to generate a first hydrodynamic cavitation field 570 downstream from the first baffle 540 via a first local constriction 575 of liquid flow. For example, the first local constriction 575 of liquid flow can be an area defined between the inner surface 520 of the wall 515 and an outside surface of the first baffle 540. Also, the second baffle 545 can be configured to generate a second hydrodynamic cavitation field 580 downstream from the second baffle 545 via a second local constriction 585 of liquid flow. For example, the second local constriction 585 can be an area defined between the inner surface 520 of the wall 515 and an outside surface of the second baffle 545.

With further reference to FIG. 5, the flow-through channel 525 can further include a fluid passage 590 for introducing a gas into the flow-through channel 525 along a path represented by arrow B. In one embodiment, the port 590 can be disposed in the wall 515 to permit the introduction of the gas into the liquid in the first local constriction 575 of flow. Beginning at the wall 515, the fluid passage 590 extends through the plate 550, the stem 555, and at least partially into the first baffle 540. It will be appreciated that the fluid passage 595 can be embodied in any shape or path. In the first baffle 540, the fluid passage terminates into at least one port 595 that extends radially from the CL of the first baffle 540 and exits in the first local constriction 575 of flow. Furthermore, it will be appreciated that the port 595 can be disposed in the first baffle 540 anywhere along the axial length of the first local constriction 575 of flow. Furthermore, it will be appreciated that any number of ports can be provided in the first baffle to introduce gas into the first local constriction 575 of flow or the port 595 can be embodied as a slot to introduce gas into the first local constriction 575 of flow.

In operation of the device 500 illustrated in FIG. 5, the liquid enters the flow-through channel 525 via the inlet 530 and moves through the at least one orifice 560 in the plate 550 along the path A. The liquid can be fed through the flow-through channel 525 and maintained at any flow rate sufficient to generate a hydrodynamic cavitation field downstream from both the first and second baffles 540, 545. As the liquid moves through the flow-through channel 525, the gas is introduced into the first local constriction 575 via the port 590 and the passage 595 thereby mixing the gas with the liquid as the liquid passes through the first local constriction 575. The gas can be introduced into the liquid in the first local constriction 575 and maintained at a flow rate different from the liquid flow rate. For example, a ratio between the gas flow rate and the liquid flow rate is about 0.1 or less. In other words, the ratio between the liquid flow rate and the gas flow rate can be at least about 10.

While passing through the first local constriction 575, the velocity of the liquid increases to a minimum velocity (i.e., velocity at which cavitation bubbles begin to appear) dictated by the physical properties of the liquid. The increased velocity of the liquid forms the first hydrodynamic cavitation field 580 downstream from the first baffle 540 thereby generating cavitation bubbles that grow when mixed with the gas. Upon reaching an elevated static pressure zone, the bubbles can be partially or completely squeezed thereby dissolving the gas into the liquid.

Once the gas microbubbles are generated after the first stage of hydrodynamic cavitation, the liquid and gas microbubbles continue to move towards the second baffle 545. While passing through the second local constriction 585, the velocity of the liquid increases to a minimum velocity (i.e., velocity at which cavitation bubbles begin to appear) dictated by the physical properties of the liquid. The increased velocity of the liquid forms the second hydrodynamic cavitation field 580 downstream from the second baffle 545 thereby generating cavitation bubbles. Upon reaching an elevated static pressure zone, a vacuum can be created in the second hydrodynamic cavitation field 580 to extract the dissolved gas from the liquid thereby generating microbubbles. The microbubbles can be smaller in size and more uniform than the microbubbles produced after the first stage of hydrodynamic cavitation. The liquid and microbubbles can then exit the flow-through channel 525 via the outlet 535.

The following examples are given for the purpose of illustrating the present invention and should not be construed as limitations on the scope or spirit of the instant invention.

### EXAMPLE 1

The following example of a method of generating microbubbles in liquid was carried out in a device substantially similar to the device 200 as shown in FIG. 2, except that the device included only one stage of hydrodynamic cavitation. Water was fed, via a high pressure pump, through the flow-through channel 225, at a flow rate of 5.68 liter per minute (l/min). Air was introduced, via a compressor, into the flow-through channel 225 via the port 270 in the first local constriction of flow 245 at a flow rate of 0.094 standard liters per minute (sl/min). Accordingly, the volume ratio of the air flow rate to the water flow rate was 0.017. The combined water and air then passed through the local constriction of flow 245 creating hydrodynamic cavitation to thereby effectuate the generation of microbubbles. The resultant bubble size of the microbubbles was between 5,000 and 7,000 microns.

### EXAMPLE 2

The following example of a method of generating microbubbles in liquid was carried out in a device substantially similar to the device 200 as shown in FIG. 2, which included two stages of hydrodynamic cavitation. Water was fed, via a high pressure pump, through the flow-through channel 225, at a flow rate of 5.68 liter per minute (l/min). Air was introduced, via a compressor, into the flow-through channel 225 via the port 270 in the first local constriction of flow 245 at a flow rate of 0.566 standard liters per minute (sl/min). Accordingly, the volume ratio of the air flow rate to the water flow rate was 0.100. The combined water and air then passed through the first and second local constrictions of flow 245, 255 creating hydrodynamic cavitation to thereby effectuate the generation of microbubbles. The resultant bubble size of the microbubbles was between 200 and 300 microns.

The method above was repeated in the device 200, except that the gas flow rate was changed. The results are illustrated in Chart 1 below.

CHART 1

| | Liquid | Gas | Volume ratio- | Bubble |
|---|---|---|---|---|
| | Flow Rate | Flow Rate | gas flow rate to | size |
| Test | (l/min) | (sl/min) | liquid flow rate | (microns) |
| 1 | 5.68 | 0.472 | 0.080 | 100-200 |
| 2 | 5.68 | 0.080 | 0.014 | 100-200 |
| 3 | 5.68 | 0.047 | 0.008 | 100-200 |
| 4 | 5.68 | 0.033 | 0.006 | 100-200 |

### EXAMPLE 3

The following example of a method of generating microbubbles in liquid was carried out in a device substantially similar to the device 200 as shown in FIG. 2, except that the device included only one stage of hydrodynamic cavitation. Water was fed, via a high pressure pump, through the flow-through channel 225, at a flow rate of 8.71 liter per minute (l/min). Air was introduced, via a compressor, into the flow-through channel 225 via the port 270 in the first local constriction of flow 245 at a flow rate of 0.212 standard liters per minute (sl/min). Accordingly, the volume ratio of the air flow rate to the water flow rate was 0.024. The combined water and air then passed through the local constriction of flow 245 creating hydrodynamic cavitation to thereby effectuate the generation of microbubbles. The resultant bubble size of the microbubbles was between 5,000 and 7,000 microns.

### EXAMPLE 4

The following example of a method of generating microbubbles in liquid was carried out in a device substantially similar to the device 200 as shown in FIG. 2, which included two stages of hydrodynamic cavitation. Water was fed, via a high pressure pump, through the flow-through channel 225, at a flow rate of 8.71 liter per minute (l/min). Air was introduced, via a compressor, into the flow-through channel 225 via the port 270 in the first local constriction of flow 245 at a flow rate of 0.614 standard liters per minute (sl/min). Accordingly, the volume ratio of the air flow rate to the water flow rate is 0.070. The combined water and air then passed through the first and second local constrictions of flow 245, 255 creating hydrodynamic cavitation to thereby effectuate the generation of microbubbles. The resultant bubble size of the microbubbles was between 200 and 300 microns.

The method above was repeated in the device 200, except that the gas flow rate was changed. The results are illustrated in Chart 2 below.

CHART 2

| | Liquid | Gas | Volume ratio- | Bubble |
|---|---|---|---|---|
| | Flow Rate | Flow Rate | gas flow rate to | size |
| Test | (l/min) | (sl/min) | liquid flow rate | (microns) |
| 1 | 8.71 | 0.472 | 0.054 | 100-200 |
| 2 | 8.71 | 0.234 | 0.027 | 100-200 |
| 3 | 8.71 | 0.080 | 0.009 | 100-200 |
| 4 | 8.71 | 0.047 | 0.005 | 100-200 |
| 5 | 8.71 | 0.033 | 0.004 | 100-200 |

### EXAMPLE 5

The following example of a method of generating microbubbles in liquid was carried out in a device substantially similar to the device 200 as shown in FIG. 2, except that the device included only one stage of hydrodynamic cavitation. Water was fed, via a high pressure pump, through the flow-through channel 225, at a flow rate of 11.4 liter per minute (l/min). Air was introduced, via a compressor, into the flow-through channel 225 via the port 270 in the first local constriction of flow 245 at a flow rate of 0.236 standard liters per minute (sl/min). Accordingly, the volume ratio of the air flow rate to the water flow rate is 0.021. The combined water and air then passed through the local constriction of flow 245 creating hydrodynamic cavitation to thereby effectuate the generation of microbubbles. The resultant bubble size of the microbubbles was between 5,000 and 8,000 microns.

### EXAMPLE 6

The following example of a method of generating microbubbles in liquid was carried out in a device substantially similar to the device 200 as shown in FIG. 2, which included two stages of hydrodynamic cavitation. Water was fed, via a high pressure pump, through the flow-through channel 225, at a flow rate of 11.4 liter per minute (1/min). Air was introduced, via a compressor, into the flow-through channel 225 via the port 270 in the first local constriction of flow 245 at a flow rate of 0.991 standard liters per minute (sl/min). Accordingly, the volume ratio of the air flow rate to the water flow rate is 0.087. The combined water and air then passed through the first and second local constrictions of flow 245, 255 creating hydrodynamic cavitation to thereby effectuate the generation of microbubbles. The resultant bubble size of the microbubbles was between 200 and 300 microns.

The method above was repeated in the device 200, except that the gas flow rate was changed. The results are illustrated in Chart 3 below.

CHART 3

| | Liquid | Gas | Volume ratio- | Bubble |
|---|---|---|---|---|
| | Flow Rate | Flow Rate | gas flow rate to | size |
| Test | (l/min) | (sl/min) | liquid flow rate | (microns) |
| 1 | 11.4 | 0.520 | 0.046 | 100-200 |
| 2 | 11.4 | 0.378 | 0.033 | 100-200 |
| 3 | 11.4 | 0.189 | 0.017 | 100-200 |
| 4 | 11.4 | 0.094 | 0.008 | 100-200 |
| 5 | 11.4 | 0.057 | 0.005 | 100-200 |
| 6 | 11.4 | 0.024 | 0.002 | 100-200 |

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

What is claimed is:

1. A method of generating microbubbles in a liquid comprising the steps of:
feeding the liquid and a gas through a flow-through chamber at respective flow rates; and
passing the liquid and gas through at least two local constrictions of flow to create hydrodynamic cavitation fields downstream from each local constriction of flow to thereby generate microbubbles.

2. The method of claim 1, wherein the at least two local constrictions of flow include an upstream local constriction of flow and a downstream local constriction of flow wherein the gas is fed into the flow-through chamber in the upstream local constriction of flow.

3. The method of claim 1, wherein the at least two local constrictions of flow include an upstream local constriction of flow and a downstream local constriction of flow wherein the gas is fed into the liquid in a region of reduced liquid pressure in the upstream local constriction of flow.

4. The method of claim 1, wherein the liquid flow rate and the gas flow rate are different from each other.

5. The method of claim 1, wherein a ratio of the liquid flow rate to the gas flow rate is at least about 10.

6. A method of generating gas microbubbles in a liquid comprising the steps of:
separately introducing the liquid and a gas into a flow-through channel at respective flow rates; and
passing the liquid and gas through an upstream local constriction of flow and a downstream local constriction of flow to create hydrodynamic cavitation fields downstream from each constriction means to thereby generate gas microbubbles downstream from the downstream local constriction of flow.

7. The method of claim 6, wherein the gas is introduced into the flow-through chamber in the upstream local constriction of flow.

8. The method of claim 6, wherein the gas is introduced into the liquid in a region of reduced liquid pressure in the upstream local constriction of flow.

9. The method of claim 6, wherein a ratio of the liquid flow rate to the gas flow rate is at least about 10.

10. A device for generating microbubbles in a liquid comprising:
a flow-through channel defined by at least one wall, the flow-through channel having an inlet configured to permit the liquid to enter the flow-through channel;
a port disposed in the at least one wall configured to introduce a gas into the liquid in the flow-through channel; and
at least two cavitation generators disposed in series within the flow-through channel, each configured to create a hydrodynamic cavitation field downstream from its respective cavitation generator to thereby effectuate the generation of microbubbles.

11. The device of claim 10, wherein the at least two cavitation generators includes a first cavitation generator and a second cavitation generator positioned downstream from the first cavitation generator.

12. The device of claim 11, wherein the first cavitation generator includes a baffle configured to produce a local constriction of flow between the baffle and the at least one wall.

13. The device of claim 12, wherein the port is positioned adjacent to the local constriction of flow and configured to permit the gas to enter the flow-through channel into the local constriction of flow.

14. The device of claim 11, wherein the first cavitation generator includes a plate having at least one orifice disposed therein to produce a local constriction of flow.

15. The device of claim 14, wherein the port is positioned adjacent to the local constriction of flow and configured to permit the gas to enter the flow-through channel into the local constriction of flow.

16. A device for generating gas microbubbles in a liquid comprising:
a flow-through chamber defined by at least one wall, the flow-through channel having an inlet configured to permit the liquid to enter the flow-through chamber;
upstream flow constriction means disposed within the flow-through channel and configured to create a hydrodynamic cavitation field downstream from the upstream flow constriction means;
a port disposed in the at least one wall adjacent to the upstream flow constriction means, the port configured to introduce a gas into the liquid in the flow-through channel; and
downstream flow constriction means disposed within the flow-through channel downstream from the upstream flow constriction means, the downstream flow constriction means configured to create another hydrodynamic cavitation field downstream from the downstream flow constriction means to effectuate the generation of gas microbubbles.

17. The device of claim 16, wherein the upstream flow constriction means includes a baffle configured to produce a local constriction of flow between the baffle and the at least one wall.

18. The device of claim 17, wherein the port is positioned adjacent to the local constriction of flow and configured to permit the gas to enter the flow-through channel into the local constriction of flow.

19. The device of claim 16, wherein the upstream flow constriction means includes a plate having at least one orifice disposed therein to produce a local constriction of flow.

20. The device of claim 19, wherein the port is positioned adjacent to the local constriction of flow and configured to permit the gas to enter the flow-through channel into the local constriction of flow.
